(19) United States
(12) Patent Application Publication
(10) Pub. No.: US 2010/0166972 A1
(43) Pub. Date: Jul. 1, 2010

(54) Aqueous Coating Composition

(75) Inventors: JUNG-HUA WENG, Taoyuan County (TW); YU-CHIH WANG, Taoyuan County (TW); SUNG-YI WENG, Taoyuan County (TW); CHENG-HUNG WENG, Taoyuan County (TW)

Correspondence Address: WPAT, PC;INTELLECTUAL PROPERTY ATTORNEYS, 7225 BEVERLY ST., ANNANDALE, VA, 22003, US

(73) Assignees: Huai Mao Corporation, Taoyuan County (TW); Dongweipaint Co., Ltd. Of Foshan City, Fo Shan City (TW)

(21) Appl. No.: 12/630,928

(22) Filed: Dec. 4, 2009

(30) Foreign Application Priority Data
Dec. 26, 2008 (TW) 097150813

(51) Int. Cl. B05D 1/04; B05D 3/02; C08L 75/04; C08L 67/00; C08L 77/00

(52) U.S. Cl. 427/458; 427/385.5; 427/388.2; 427/389; 427/393.5; 427/386; 524/500; 524/507; 524/539; 524/538

(57) ABSTRACT

The present invention discloses an aqueous coating composition, comprising: (A) a water-soluble resin and (B) a cross-linking agent. The water-soluble resin after amination is evenly dispersed in a water-soluble solvent and the water-soluble resin is selected from the group consisting of the following or combination thereof: acrylic resin, alkyd resin, epoxy resin, polyurethane resin and polyester resin. The cross-linking agent at least has the function of promoting the reaction and enhancing the interaction force between the water-solution resin and a coating substrate. The function of the cross-linking agent is to have the water-soluble resin be dried naturally or compulsorily.

### BACKGROUND OF THE INVENTION

1. Field of the Invention

The present invention is generally related to a coating composition, and more particularly to an aqueous coating composition.

2. Description of the Prior Art

In general, for objects like various buildings, various furniture, decoration, electronic devices, house wares, and etc., in order to have excellent appearance and become more valuable, the exterior surface of the object is coated with various colors or patterns by coating compositions to promote its value and achieve better appearance.

A commonly-seen coating composition usually is oily paint, mainly comprising eight heavy metals (Pb, Sb, As, Ba, Cd, Cr, Hg, Se). When the paint is in use, a solvent like banana oil or turpentine is used as a thinner to dilute the paint in order to have the paint be coated on the object like various buildings, various furniture, decoration, electronic devices, house wares, and etc. However, the heavy metals in the oily paint are toxic and the thinner, banana oil or turpentine, containing toluene or xylene, is also toxic, it will cause a health problem to a user or worker to use such paint. Besides, since the above constituents are combustible, it is possible to cause fire while applying such paint. Moreover, since these constituents are extracted from petroleum, the replacements of such constituents are urgently required due to the shortage of petroleum supply.

Although nowadays most of coating compositions tend to be aqueous and the toxic substances in oily paint are avoided, in order to coat the aqueous coating composition, it requires firstly coating a primer, then coloring, coating a median coating layer, and finally coating a surface layer that causes tremendous inconvenient while applying the aqueous coating composition. In addition, after the aqueous coating composition is applied on the surface of the object, the surface needs to be polished and the surface may have an orange peel phenomenon due to lack of chubbiness, or have bad adherence and bad fastness so that the surface may become de-colored or have bad appearance. These problems are required to be solved.

### SUMMARY OF THE INVENTION

In light of the above background, in order to fulfill the industrial requirements, the invention provides an aqueous coating composition.

For further detailed description, the present invention is related to an aqueous coating composition, comprising: (A) a water-soluble resin and (B) a cross-linking agent. The water-soluble resin after amination is evenly dispersed in a water-soluble solvent and is selected from the group consisting of the following or combination thereof: acrylic resin, alkyd resin, epoxy resin, polyurethane resin and polyester resin. The cross-linking agent at least has the function of promoting the reaction and enhancing the interaction force between the water-solution resin and a to-be-coated substrate. The function of the cross-linking agent is to have the water-soluble resin be dried naturally or compulsorily.

Accordingly, the aqueous coating composition of the present invention is an eco-coating material with no benzene, no lead, and no heavy metal and also has a good mechanical property and no surface release problem. Besides, the product made by the coating composition has no dripping phenomenon during baking and coating so that the product can be applied as a molding object in the industries like electrics, electronics, wood work, plastics, information, telecommunication, and automobile.

### DESCRIPTION OF THE PREFERRED EMBODIMENTS

What is probed into the invention is an aqueous coating composition. Detail descriptions of the steps and compositions will be provided in the following in order to make the invention thoroughly understood. Obviously, the application of the invention is not confined to specific details familiar to those who are skilled in the art. On the other hand, the common steps and compositions that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

In a first embodiment of the present invention, an aqueous coating composition is provided. The aqueous coating composition comprises (A) a water-soluble resin and (B) a cross-linking agent. The water-soluble resin after amination is evenly dispersed in a water-soluble solvent and is selected from the group consisting of the following or combination thereof: acrylic resin, alkyd resin, epoxy resin, polyurethane resin and polyester resin. The cross-linking agent at least has the function of promoting the reaction and enhancing the interaction force between the water-solution resin and a to-be-coated substrate. The function of the cross-linking agent is to have the water-soluble resin be dried naturally or compulsorily. In a preferred example, the cross-linking agent is a thermoplastic urethane resin which is preferred to be a thermoplastic melamine-formaldehyde resin and preferably its reaction temperature is less than or equal to 80° C. In a preferred example, the cross-linking agent is a thermosetting urethane resin which is preferred to be a thermosetting melamine-formaldehyde resin and preferably its reaction temperature is between 80° C. and 300° C.

The definition for drying compulsorily is a method not to dry naturally, comprising: low-temperature baking, high-temperature baking, and median-high-temperature baking.

The above aqueous coating composition further comprises an additive. The additive is selected from the group consisting of the following or combination thereof: dispersant, wetting agent, defoamer, promoter, leveling agent, light stabilizing agent, anti-dust agent, matting agent (powder), catalyst, ultraviolet absorber, and suspending agent.

There are a variety of defoamers, such as organic siloxane, polyether, silicone and ether graft polymer, amino-containing compounds, imines, amines, and etc. The defoamer has a high defoaming speed, long defoaming time, and a wide variety of applicable media, and is durable in a severe medium environment like a high-temperature, strong acidic or strong alkaline environment. The defoamers are widely applied in removing unwanted bubbles during the production process of the industry like latex, sizing, food fermentation, biomedicine, coating, petroleum, papermaking, industrial cleaning, and etc.

The so-called “bubble” means undissolved gas existing in a liquid or solid or a thin film of liquid filled with air or gas. The state that many bubbles aggregate together and are separated by thin films is called “foam”. Bubbles are a dispersed system having gas/liquid, gas/solid, and gas/liquid/solid interfaces. If there is a surfactant in the solution, after bubbles are formed, due to intermolecular forces, hydrophilic and hydrophobic groups in the molecule adsorb to the wall of bubbles to regularly arrange where the hydrophilic groups face the water phase and the hydrophobic groups face the inward of the bubble. Thus, an elastic membrane is stably formed on the interface of the bubble and cannot be easily destroyed under normal circumstances. The stability of foam is related to factors, such as the viscosity and elasticity of a surface, electric repulsion, and the mobility, temperature, evaporation of the membrane. Besides, bubble forming is related to the inverse of the surface tension of a liquid. That is, the smaller the surface tension, the easier bubble forming. Any factor that can destroy the stability of foam can be used as a defoamer. Defoaming includes suppressing foam forming and destroying foam. Organic siloxane has such function, reducing the surface tension of water, solution, suspension and etc. to prevent foam forming or to reduce foam. Generally, it has selectivity. In general, a physical defoaming method is hard to eliminate foam immediately but chemical and interface defoaming is more effective and faster. Thus, a defoamer is an agent having the effect of chemical and interface defoaming. Low-carbon alcohol, mineral oil, organic polar compounds or silicone can be used as a defoamer. In addition, the defoamer should have properties of strong defoaming ability, being chemically stable, being inert, high heat durability, high oxygen durability, corrosion resistance, gas dissolution ability, air permeability, being easy to diffuse, being easy to soak, being hard to dissolve in a to-be-defoamed system, no physical and chemical effect, low usage, and high efficiency.

A leveling agent is a common coating coagent that can assist the coating material in forming a smooth slippery uniform film during the drying and film forming processes. Accompanying with the requirement of good coating appearance, the usage and type of the leveling agent are increased. There are a variety of leveling agents. The leveling agent is different for different coating materials. For oily coating materials, the commonly used leveling agent is acrylate polymers. For aqueous coating materials, the commonly used leveling agent is polyurethanes that are made by having polyethylene oxide react with isocyanate and then performing aliphatic modification. Other coagents like organic silicones and associative alkali swelling thickening agents have a leveling effect.

Moreover, the present invention discloses a method for coating an aqueous coating composition on the surface of a substrate. The method comprises: at first coating the aqueous coating composition on the surface of the substrate; and then performing a drying process to dry the aqueous coating composition. The aqueous coating composition comprises (A) a water-soluble resin and (B) a cross-linking agent. The water-soluble resin after amination is evenly dispersed in a water-soluble solvent and is selected from the group consisting of the following or combination thereof: acrylic resin, alkyd resin, epoxy resin, polyurethane resin and polyester resin. The cross-linking agent at least has the function of promoting the reaction and enhancing the interaction force between the water-solution resin and a coating substrate. The function of the cross-linking agent is to have the water-soluble resin be dried naturally or compulsorily. In a preferred example, the cross-linking agent is a thermoplastic urethane resin which is preferred to be a thermoplastic melamine-formaldehyde resin and preferably its reaction temperature is less than or equal to 80° C. In a preferred example, the cross-linking agent is a thermosetting urethane resin which is preferred to be a thermosetting melamine-formaldehyde resin and preferably its reaction temperature is between 80° C. and 300° C.

In addition, the aqueous coating composition further comprises an additive. The additive is selected from the group consisting of the following or combination thereof: dispersant, wetting agent, defoamer, promoter, leveling agent, light stabilizing agent, anti-dust agent, matting agent (powder), catalyst, ultraviolet absorber, and suspending agent.

The aqueous coating composition can be coated on any surface of a substrate. The substrate includes metal, alloy, computer case, wood work, plastics, leather, stone, electroplated surface and etc. The method to coat the aqueous coating composition on the surface of the substrate is selected from the group consisting of the following or combination thereof: spraying, dipping, roller-coating, curtain-coating, electrostatic coating and automatically-deposited coating. The drying process is selected from the group consisting of the following or combination thereof: naturally drying, low-temperature baking, high-temperature baking, and median-high-temperature baking.

### EXAMPLE 1

The present invention provides an aqueous coating composition for metal. The aqueous coating composition comprises (A) a water-soluble resin and (B) a cross-linking agent. The water-soluble resin after amination is evenly dispersed in a water-soluble solvent and is selected from the group consisting of the following or combination thereof: acrylic resin, alkyd resin, epoxy resin, polyurethane resin and polyester resin. The cross-linking agent at least has the function of promoting the reaction and cross-linking the water-soluble resin and the to-be-coated object. The cross-linking agent is a thermosetting melamine-formaldehyde resin. The aqueous coating composition further comprises at least an additive. The additive is selected from the group consisting of the following or combination thereof: dispersant, wetting agent, defoamer, promoter, leveling agent, light stabilizing agent, anti-dust agent, matting agent (powder), catalyst, ultraviolet absorber, and suspending agent. After the above aqueous coating composition is coated on the metallic surface or electroplated surface, it is baked in a median-high-temperature oven, about 120° C. for 30 minutes or 300° C. for 1 minute.

### EXAMPLE 2

The present invention provides an aqueous coating composition for wood work. The aqueous coating composition comprises (A) a water-soluble resin and (B) a cross-linking agent. The water-soluble resin after amination is evenly dispersed in a water-soluble solvent and is selected from the group consisting of the following or combination thereof: acrylic resin, alkyd resin, epoxy resin, polyurethane resin and polyester resin. The cross-linking agent at least has the function of promoting the reaction and cross-linking the water-soluble resin and the to-be-coated object. The cross-linking agent is a thermoplastic melamine-formaldehyde resin. The aqueous coating composition further comprises at least an additive. The additive is selected from the group consisting of the following or combination thereof: dispersant, wetting agent, defoamer, promoter, leveling agent, light stabilizing agent, anti-dust agent, matting agent (powder), catalyst, ultraviolet absorber, and suspending agent. After the above aqueous coating composition is coated on the metallic electroplated surface or the surface of plastics or wood work, it is baked at the temperature below about 100° C. or naturally dried.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. An aqueous coating composition, comprising:
(A) a water-soluble resin wherein the water-soluble resin after amination is evenly dispersed in a water-soluble solvent; and
(B) a cross-linking agent, at least having the function of promoting the reaction and enhancing the interaction force between the water-solution resin and a to-be-coated substrate, wherein the cross-linking agent is a thermoplastic urethane resin.

2. The composition according to claim 1, wherein the water-soluble resin is selected from the group consisting of the following or combination thereof: acrylic resin, alkyd resin, epoxy resin, polyurethane resin and polyester resin.

3. The composition according to claim 1, wherein the water-soluble resin further comprises a pigment.

4. The composition according to claim 1, further comprising: an additive wherein the additive is selected from the group consisting of the following or combination thereof: dispersant, wetting agent, defoamer, promoter, leveling agent, light stabilizing agent, anti-dust agent, matting agent (powder), catalyst, ultraviolet absorber, and suspending agent.

5. The composition according to claim 1, wherein the function of the cross-linking agent is to have the water-soluble resin be dried naturally or compulsorily.

6. The composition according to claim 1, wherein the thermoplastic urethane resin is a melamine-formaldehyde resin.

7. A method for coating an aqueous coating composition on the surface of a substrate, comprising:
coating the aqueous coating composition according to claim 1 on the surface of the substrate; and
performing a drying process to dry the aqueous coating composition.

8. The method according to claim 7, wherein the substrate comprises one material selected from the group consisting of the following or combination thereof: metal, alloy, computer case, wood work, plastics, leather, stone or electroplated surface.

9. The method according to claim 7, wherein the method to coat on the surface of the substrate is selected from the group consisting of the following or combination thereof: spraying, dipping, roller-coating, curtain-coating, electrostatic coating and automatically-deposited coating.

10. The method according to claim 7, wherein the drying process is selected from the group consisting of the following or combination thereof: naturally drying, low-temperature baking, high-temperature baking, and median-high-temperature baking.

11. An aqueous coating composition, comprising:
(A) a water-soluble resin, which is selected from the group consisting of the following or combination thereof: acrylic resin, alkyd resin, epoxy resin, polyurethane resin and polyester resin;
(B) a cross-linking agent, having the function of at least promoting the reaction and enhancing the interaction force between the water-solution resin and a coating substrate; and
(C)an additive, which is selected from the group consisting of the following or combination thereof: dispersant, wetting agent, defoamer, promoter, leveling agent, light stabilizing agent, anti-dust agent, matting agent (powder), catalyst, ultraviolet absorber, and suspending agent.

12. The composition according to claim 11, wherein the water-soluble resin further comprises a pigment.

13. The composition according to claim 11, wherein the polyurethane resin is a melamine-formaldehyde resin.

14. A method for coating an aqueous coating composition on the surface of a substrate, comprising:
coating the aqueous coating composition according to claim 11 on the surface of the substrate; and
performing a drying process to dry the aqueous coating composition.

15. The method according to claim 14, wherein the substrate comprises one material selected from the group consisting of the following or combination thereof: metal, alloy, computer case, wood work, plastics, leather, stone or electroplated surface.

16. The method according to claim 14, wherein the method to coat on the surface of the substrate is selected from the group consisting of the following or combination thereof: spraying, dipping, roller-coating, curtain-coating, electrostatic coating and automatically-deposited coating.

17. The method according to claim 14, wherein the drying process is selected from the group consisting of the following or combination thereof: naturally drying, low-temperature baking, high-temperature baking, and median-high-temperature baking.
